(19) United States
(12) Patent Application Publication
(10) Pub. No.: US 2010/0161607 A1
(43) Pub. Date: Jun. 24, 2010

(54) SYSTEM AND METHOD FOR ANALYZING GENOME DATA

(76) Inventors: Jasjit Singh, Madison, WI (US); Kurt Heilman, Madison, WI (US)

Correspondence Address: BARNES & THORNBURG LLP, 11 SOUTH MERIDIAN, INDIANAPOLIS, IN, 46204, US

(21) Appl. No.: 12/613,776

(22) Filed: Nov. 6, 2009

Related U.S. Application Data
(60) Provisional application No. 61/139,990, filed on Dec. 22, 2008.

(51) Int. Cl. G06F 17/30

(52) U.S. Cl. 707/737; 707/769; 707/E17.108; 707/E17.046

(57) ABSTRACT

A system and method for analyzing genome data includes receiving genome analysis data generated by a genome analysis device, such as a microarray scanner, reducing the genome analysis data, and transmitting the reduced genome analysis data over a wide area network to a client computer. The reduced genome analysis data may provide a summary of the unreduced genome analysis data. One of several methods may be used to reduce the genome analysis data for transmittal over the wide area network.

### CROSS-REFERENCE TO RELATED U.S. PATENT APPLICATION

This application claims priority under 35 U.S.C. §119(e) to U.S. Provisional Patent Application Ser. No. 61/139,990 entitled “SYSTEMS AND METHODS FOR DATA VISUALIZATION AND ANALYSIS,” by Jasjit Singh et al., which was filed on Dec. 22, 2008, the entirety of which is hereby incorporated by reference.

### TECHNICAL FIELD

The present disclosure relates to systems and method for analyzing genome data and, more particularly, to systems and methods for analyzing, summarizing, and distributing a large genome data set over a networked environment.

### BACKGROUND

There are many experimental technologies used to support a broad range of biological research endeavors. One such technology is genome wide analysis, which may use various microarray formats such as, for example, formats for elucidation of gene expression, comparative genomics from genus to genus or species to species, and epigenetic modifications. Genome wide analysis and other research and analysis technologies often produce massive amounts of data that must be reviewed and analyzed by a researcher to discover aspects of the data of interest.

Oftentimes, the data generated by the research experiment/analysis may be stored remotely from the researcher. For example, the research experiment may be performed by a third-party, which may store the generated data in a database controlled by the third-party. As such, in order to perform further analysis and research on the generated data, the massive amount of data generated by the research experiment must be transmitted to the researcher, usually over a rather slow network such as the Internet. Due to the size the generated data, transfer of the experiment data over the network can be very time intensive resulting in a loss of valuable analysis time for the researcher. Additionally, the massive size of the generated data may overwhelm the research and/or hide important detail of interest to the researcher.

### SUMMARY

According to on aspect, a system for analyzing genome data may include a processor and a memory device communicatively coupled to the processor. The memory device may have stored therein a plurality of instructions, which when executed by the processor, cause the processor to receive genome analysis data generated by a genome analysis device. The genome analysis data may include a plurality of data points. The plurality of instructions may also cause the processor to receive a request for genome analysis data from a client computer over a wide area network. The request may identify a location range of interest of the genome analysis data. The plurality of instructions may also cause the processor to reduce the genome analysis data located in the location range to generate a reduced genome dataset. The reduced genome dataset may include a first number of data points that is less than a second number of data points of the genome analysis data located in the location range and outlier metrics. Additionally, the plurality of instructions may cause the processor to transmit the reduced genome dataset to the client computer over the wide area network in response to the request.

In some embodiments, the genome analysis data may be embodied as genome analysis data generated from a microarray assay performed using a microarray scanner. For example, the microarray assay may be a nucleic acid microarray assay or a peptide microarray assay in some embodiments. Additionally, the microarray assay may be embodied as a nucleic acid microarray assay including genomic deoxyribonucleic acid samples.

In some embodiments, the request may identify a start location and a stop location of the genome analysis data, the location range extending from the start location to the end location. Additionally, in some embodiments, the first number of data points may be no greater than ten percent of the second number of data points. For example, in a particular embodiment, the first number of data points may be no greater than one percent of the second number of data points. Additionally, the size in bytes of the reduced genome dataset may be less than about one percent of the size in bytes of the genome analysis data located in the location range.

The outlier metrics may include data points that represent at least one of values above a determined maximum and values below a determined minimum. Additionally or alternatively, the outlier metrics may include data points having numerical values falling outside a predetermined deviation range of a determined average value. The reduced genome dataset may include a mean data point value, a median data point value, a minimum data point value, and a maximum data value in some embodiments.

The processor may reduce genome analysis data may be by defining a plurality of data bins, each data bin being assigned an associated sub-range of the location range, allocating each data point of the genome analysis data located in a sub-range of the location range to the corresponding data bin, and summarizing the plurality of data bins by defining at least a mean data point value, a median data point value, a minimum data point value, and a maximum data point value for each data bin. Further, the wide area network may be embodied as the Internet. Additionally, in some embodiments, the genome analysis data may include first genome analysis data generated from an analysis of a test nucleic acid sample and second genome data analysis data generated from a reference nucleic acid sample. In such embodiments, the plurality of instructions further cause the processor to identify at least one data point of the first genome analysis data that is different in value from a corresponding data point of the second genome analysis data, wherein the reduced genome dataset comprises the at least one data point.

Accordingly, to another aspect, a method for analyzing genome data may include receiving, with a computer system, a request for gnome analysis data from a client computer over the Internet. The request may identify a location range of interest of the genome analysis data. The method may also include reducing, on the computer system, the genome analysis data located in the location range to generate a reduced genome dataset such that the reduced genome dataset summarizes the genome analysis data located in the location range and the size in bytes of the reduced genome dataset is no greater than one percent of the size in bytes of the genome analysis data located in the location range. Additionally, the method may include transmitting the reduced genome dataset from the computer system to the client computer over a wide area network.

In some embodiments, reducing the genome analysis data may include determining outlier metrics. Such outlier metrics may include data points having numerical values falling outside a predetermined deviation range of a determined average value. Additionally or alternatively, reducing the genome analysis data may include determining a mean data point value, a median data point value, a minimum data point value, and a maximum data value based on the genome analysis data located in the location range. Additionally or alternatively, reducing the genome analysis data may include defining a plurality of data bins, each data bin being assigned an associated sub-range of the location range, allocating each data point of the genome analysis data located in a sub-range of the location range to the corresponding data bin, and summarizing the plurality of data bins by defining at least a mean data point value, a median data point value, a minimum data point value, and a maximum data point value for each data bin. Additionally, in some embodiments, transmitting the reduced genome dataset may include transmitting the reduced genome dataset from the computer system to the client computer over the Internet during a first time period that is less than a time period required to transmit the genome analysis data located in the location range to the client computer.

According to a further aspect, a tangible, machine readable medium may comprise a plurality of instructions, which in response to being executed, result in a computing system receiving genome analysis data including first genome analysis data generated from a microarray analysis of a test nucleic acid sample and second genome data analysis data generated from a reference nucleic acid sample. The plurality of instructions may further cause the computing system to identify at least one data point of the first genome analysis data that is different in value from a corresponding data point of the second genome analysis data. Additionally, the computing system may reduce the genome analysis data located in the location range to generate a reduced genome dataset. Such reduced genome dataset may include a first number of data points that is less than a second number of data points of the genome analysis data and the at least one data point. Further, the plurality of instructions may cause the computing system to transmit the reduced genome dataset to a client computer over a wide area network in response to a request received from the client computer.

### DESCRIPTION OF THE DRAWINGS

FIG. 1 is a simplified block diagram of one embodiment a system for analyzing genome data;

FIG. 2 is a simplified flow diagram of one embodiment of a method for analyzing genome data used by the system of FIG. 1;

FIG. 3 is a simplified flow diagram of one embodiment of a method for reducing genome data used in the method of FIG. 2; and

FIG. 4 is one embodiment of a display screen illustrating various methods for displaying the reduced data to a user of a client computer of the system of FIG. 1.

### DETAILED DESCRIPTION

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present disclosure. It will be appreciated, however, by one skilled in the art that embodiments of the disclosure may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Some embodiments of the disclosure, or portions thereof, may be implemented in hardware, firmware, software, or any combination thereof. Embodiments of the disclosure may also be implemented as instructions stored on a tangible, machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; and others.

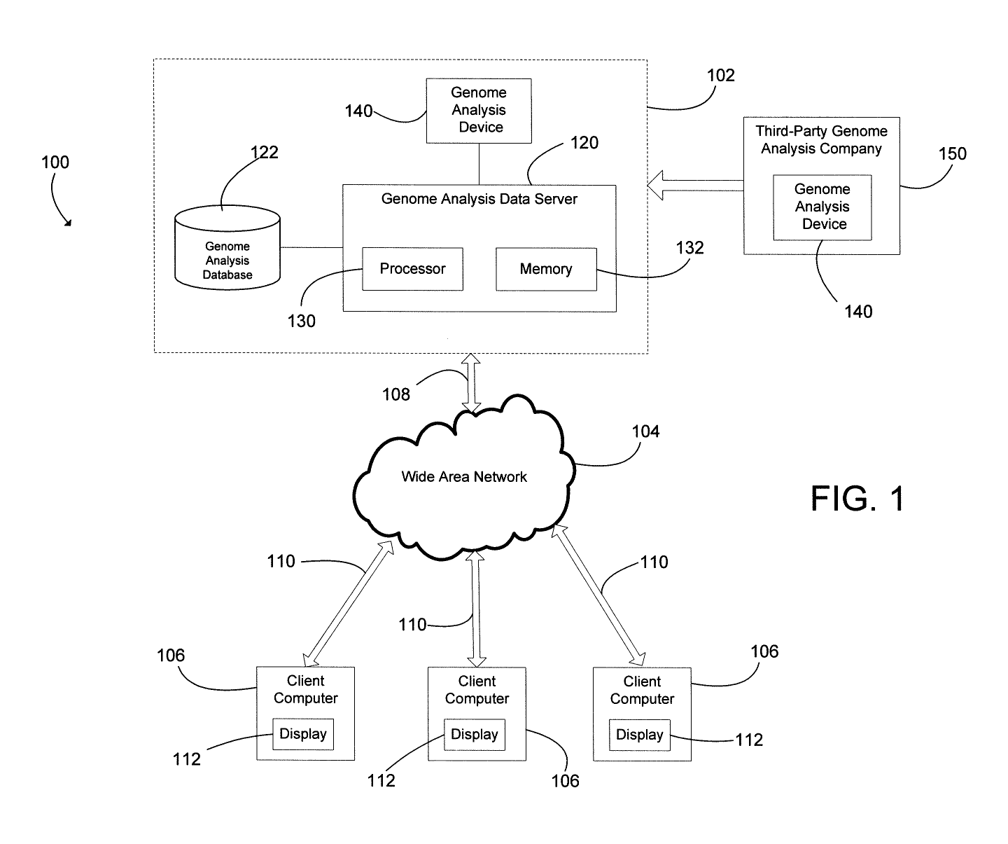

Referring to FIG. 1, a system 100 for analyzing genome analysis data includes a server computer system 102, a wide area network 104, and one or more client computers 106. The server computer system 102 and client computers 106 are configured to communicate with each other over the network 104. To facilitate such communication, the server computer system 102 is communicatively coupled to the wide area network 104 via a communication path 108. Similarly, each of the client computers 106 are communicatively coupled to the wide area network 104 via respective communication paths 110. Each of the communication paths 108, 110 may be embodied as any number of wires, cables, and/or devices (e.g., network gateway computers) capable of facilitating data communication between the server computer system 102 and the network 104 and between the client computers 106 and the network 104, respectively.

The wide area network 104 may be embodied as any type of wide area network capable of facilitating communication between the server computer system 102 and the client computers 106. For example, in one particular embodiment, the wide area network 104 is embodied as a publicly-available, global network such as the Internet. Additionally, the network 104 may include any number of additional devices to facilitate the communication between the server computer system 102 and the client computers 106 routers, switches, intervening computers, and/or the like. It should be appreciated that the wide area network 104 supports lower data transfer speeds (i.e., bandwidth) relative to a direct communication link between the server computer system 102 and the computer clients 106 or a typical local area network.

Each of the client computers 106 may be embodied as any type of computer or computing device capable of communicating with the server system 102 over the network 104. For example, each client computer 106 may be embodied as a desktop computer, mobile or laptop computer, a hand-held computing device such as personal data assistants, a mobile Internet device (MID), or a cellular phone, or other network-enabled computing device. Additionally, each client computer 106 includes a display device 112, which may be embodied as any type of display device capable of displaying data to the user of the client computer 106. For example, the display device 112 may be embodied as a liquid crystal display (LCD), a light emitting diode (LED) display, a plasma display, or other display screen or device.

The server computer system 102 includes a genome analysis data server 120. The server 120 may be embodied as one or more computers configured to store, reduce, and transmit genome analysis data to the client computers 106 as discussed in more detail below. The data server 120 includes a processor 130 and a memory device 132. The processor 130 may be embodied as any type of processor capable of performing the functions described herein. Illustratively, the processor 130 is embodied as a single core processor. However, in other embodiments, the processor 130 may be embodied as a multi-core processor having multiple processor cores. Additionally, the genome analysis data server 120 may include additional processors 130 having one or more processor cores in other embodiments.

The memory device 132 may be embodied as one or more memory devices or data storage locations including, for example, dynamic random access memory devices (DRAM), synchronous dynamic random access memory devices (SDRAM), double-data rate dynamic random access memory device (DDR SDRAM), and/or other volatile memory devices. Although only a single memory device 132 is illustrated in FIG. 1, in other embodiments, the genome analysis data server 120 may include additional memory devices. Additionally, the genome analysis data server 120 may include other devices and peripherals such as those found in a typical server or computer including, but not limited to, communication circuitry, display device, input/output peripherals, and/or the like.

The server computer system 102 also includes a gnome analysis database 122. The database 122 may be embodied as any type of database for storing genome analysis data. For example, the database 122 may be embodied as stand-alone computing device separate from the data server 120, as a storage device such as a hard drive or memory device incorporated in or separate from the data server 120, one or more files, memory locations, or other data structures, which may be incorporated in, stored in, or otherwise associated with the data server 120. Additionally, although only a single database 122 is illustrated in FIG. 1, it should be appreciated that the server computer system 102 may include any number of databases 122 in other embodiments.

The server computer system 102 may also include one or more genome analysis devices 122 in some embodiments. Such devices may be configured to perform one or more analysis on various genome samples and generate genome analysis data based thereon. For example, the genome analysis device may be embodied as a microarray scanner in some embodiments. In one particular embodiment, the genome analysis device 122 is embodied as a Genepix® model microarray (e.g., 4000B, 4100A, 4200A, 4200L), which is commercially available from Molecular Devices of Sunnyvale, Calif. However, in other embodiments, other microarray scanners may be used. For example, microarray scanners usable with the system 100 may include, but are not limited to, Agilent Microarray scanners, which are commercially available from Agilent Technologies, Inc. of Santa Clara, Calif.; Arrayit® Microarray scanners, which are commercially available from Arrayit Corporation of Sunnyvale, Calif.; Affymetrix GeneChip® Microarray scanners, which are commercially available from Affymetrix, Inc. of Santa Clara, Calif.; InnoScan® Microarray scanners, which are commercially available from Innopsys of Carbonne, France; ScanArray® Microarray scanners, which are commercially available from PerkinElmer of Waltham, Mass.; Revolution® Microarray scanners, which are commercially available from VIDAR Systems Corporation of Herndon, Va.; and/or the NimbleGen MS200 and MS250 fluorescent scanners, which are commercially available from Roche NimbleGen, Inc. of Madison, Wis.

In some embodiments, the genome analysis device 140 may be operated by a third-party 150. In such embodiments, the third-party 150 may perform the genome analysis to generate the genome analysis data, which is provided to the server computer system 102. As discussed above, the computer system 102 may store the genome analysis data in the database 122. It should also be appreciated that the server computer system 102 may include other computers, devices, and/or software to facilitate the functionality described herein. For example, the system 102 may include a gateway computer or interface to facilitate communication between the genome analysis data server 120 and the wide area network 104, additional data servers 120 or other analysis computers, additional databases 122, and/or other additional computing devices and systems.

In use, the server computer system 102 is configured to store genome analysis data generated by one or more genome analysis devices 140 in the database 122. In response to a request for genome data received by one or more of the remote client computes 106, the server computer system 102 is configured to reduce and/or summarize the genome data based on parameters provided with the request and transmit the requested genome data over the relatively slower wide area network 104 to the client computers 106. To do so, the system 102 may execute a method 200 for analyzing and distributing genome data.

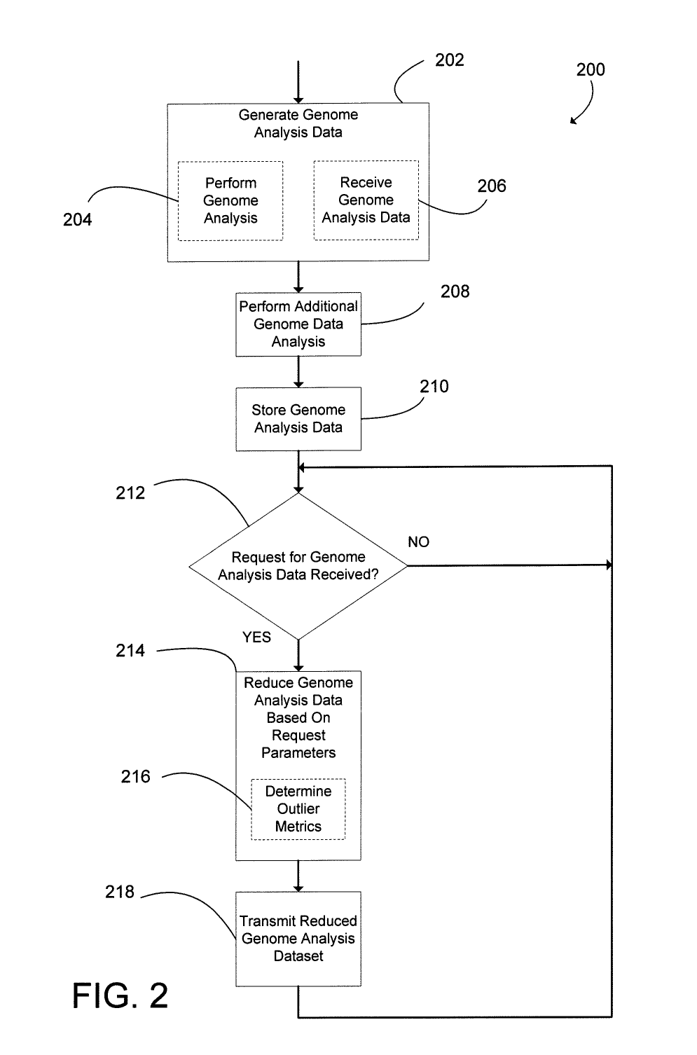

As illustrated in FIG. 2, the method 200 to begins with process block 202 in which genome analysis data is generated. As discussed above, the genome analysis data may be generated by performing one or more genome analysis test/experiments using the genome analysis device 140. As discussed above, the genome analysis device 140 may be incorporated in the server computer system 102 or may be operated by the third-party 150. In embodiments wherein the genome analysis device 140 is incorporated in the server computer system 102, the genome analysis is performed in block 204 and genome analysis data is generated therefrom. Alternately, in embodiments wherein the genome analysis device 140 is operated by the third-party 150, the genome analysis is performed by the third-party 150; and the genome analysis data is received by the system 102 from the third-party 150 in block 206.

As discussed above, in some embodiments, the genome analysis performed in block 202 may be embodied as a microarray analysis. In such embodiments, the microarrays may be fabricated using one of a variety of fabrication methods. For example, the microarrays may be fabricated by drop deposition of monomers for in situ fabrication or polynucleotide deposition. Such methods of microarray fabrication are illustratively described in, for example, U.S. Pat. No. 6,242,266; U.S. Pat. No. 6,232,072; U.S. Pat. No. 6,180,351; U.S. Pat. No. 6,171,797; and U.S. Pat. No. 6,323,043. Additionally, photolithographic fabrication of microarrays wherein masks are used to sequentially add monomers to create oligomers are illustratively described in, for example, U.S. Pat. No. 5,143,854; U.S. Pat. No. 5,405,783; U.S. Pat. No. 5,412,087; U.S. Pat. No. 5,424,186; U.S. Pat. No. 5,510,270; U.S. Pat. No. 5,624,711; U.S. Pat. No. 5,919,523; U.S. Pat. No. 6,379,895; U.S. Pat. No. 6,630,308; U.S. Pat. No. 6,949,638; and U.S. Pat. No. 7,144,700. Additionally, fabrication of microarrays may be performed using maskless array synthesis as illustratively described in, for example, U.S. Pat. No. 6,315,958, U.S. Pat. No. 6,375,903, U.S. Pat. No. 6,444,175, U.S. Pat. No. 7,083,975, U.S. Pat. No. 7,157,229, U.S. Pat. No. 7,422,851, U.S. Patent Application Publication 2004/0126757, U.S. Application Patent 2004/0101949, U.S. Application Patent 2007/0037274 and U.S. Application Patent 2007/014096.

In some embodiments, the microarrays may be embodied as polynucleotide or polypeptide assays. In such embodiments, the polynucleotides include Deoxyribonucleic acid (DNA), Ribonucleic acid (RNA), mRNA, tRNA, mitochondrial RNA, or micro RNA (miRNA), etc. Additionally, in embodiments wherein DNA is being analyzed, the DNA may be genomic fragmented (e.g., sonicated, nebulized, restriction enzyme digested, sheared), or whole (e.g., not intentionally fragmented). For example, in some embodiments a microarray assay is a nucleic acid assay for comparative genomic hybridization (CGH) for identification of insertions and/or deletions in a genome wherein both a reference genomic DNA sample and a test genomic DNA sample are compared.

In embodiments wherein polynucleotide arrays are used, probes may be affixed to a microarray substrate (e.g., slide, chip, bead, tube, column, etc.) utilizing methods as described above or additional known methods for affixing probes to substrates. In some embodiments, the probes may be designed to capture target sequences and may be labeled with a detectable moiety or not labeled, wherein the target sequences are instead labeled with a detectable moiety (e.g., luminescent moiety such as a fluorophore or luminophore, radioactive moiety, etc.). The probes fabricated on the substrate may be of many different types, for example negative control probes, positive control probes, probes for only one target sequence or probes for more than one target sequence, tiling probes, etc. A target sample may be applied to the microarray and conditions allowed to permit hybridization may be carried out. The microarray is subsequently assayed on the genome analysis device 140, which is configured to detect the detection moiety utilized in the experiment (e.g., a fluorescent scanner, luminometer, radiometer, etc.).

It should be appreciated that each of the genome analysis devices 140 may include associated software internal and/or external thereto for acquiring microarray data signals generated from a microarray scan (e.g., fluorescence, luminescence, radiometric, etc.). Such associated software may also include external software, for example data analysis and/or visualization software. It should be appreciated that a massive amount of data points may be generated by each assayed microarray. For example, datasets least 50,000 data points, at least 60,000 data points, at least 70,000 data points, at least 100,000 data points, at least 300,000 data points, at least 500,000 data points, at least 750,000 data points, at least 1,000,000 data points, at least 2,000,000 data points, at least 4,000,000 data points, or at least 8,000,000 data points may be generated. Such datasets may be imported into and visualized on a local computing device or system (e.g., the genome analysis data server 120 or other computer or computing device of the system 102) using a visualization program, such as SignalMap™, which is commercially available from Roche NimbleGen, Inc. of Madison, Wis., and/or analyzed using a data analysis program, such as NimbleScan™, which is also commercially available Roche NimbleGen, Inc. of Madison, Wis.

Referring back to FIG. 2, additional genome data analysis may be performed on the genome analysis data in block 208. For example, in some embodiments, the genome data analysis from different tests or experiments is compared to each other in block 208. For example, a test nucleic acid sample and a reference nucleic acid sample may be analyzed. Subsequently, in block 208, differences between the data points generated from the test sample and the reference sample may be determined. Of course, other types of samples and analysis may be used in other embodiments.

Once any additional genome data analysis has been completed in block 208, the genome analysis data, and any associated data (e.g., additional data generated during the additional analysis performed in block 208) is stored in block 210. The genome analysis data may be stored in the genome analysis database 122 or other storage location for subsequent retrieval by the genome analysis data server 120.

In block 212, the server computer system 102 determines whether a request for genome analysis data has been received from one or more client computers 106. A user of one of the client computers 106 may transmit a request to the server computer system 102 via the wide area network 104. In some embodiments, the request may include one or more request parameters. The request parameters may define a particular location or range of data of the genome analysis data of interest to the researcher or user of the client computer 106. That is, rather than downloading the complete dataset of the genome analysis data, the researcher may specific a location range of genome analysis data. It should be appreciated, however, that the data associated with the specified location range is likely still massive and will require significant time to transmit to the client computer when in a non-reduced form.

If a request for genome data is received in block 212, the genome analysis data server 102 reduces the genome analysis data to generate a reduced genome dataset in block 214. One or more various methods to reduce the size of the genome analysis data may be used in block 214. For example, the overall size in bytes of the genome analysis data may be reduced. In some embodiment, the number of data points included in the reduced genome dataset may be less than 50%, less than 10%, and/or less than 1% of the number of data points included in the corresponding unreduced genome analysis data. For example, if the genome analysis data includes 1,000,000 data points and has a size of about 100 megabytes, such analysis data may be reduced to 1,000 data points or less having a size of about 100 Kilobytes.

It should be appreciated that the total number of data points and other data, as well as the overall size, of the reduced genome dataset may vary depending on the particular reduction methodology used in block 214. For example, in those embodiments in which the request parameters include indicia of a location range of interest, only the data located within the specific location range may be reduced in block 214. For example, the request received from the client computers 106 in block 212 may include a start location and a stop location. In such embodiments, the location range may be defined as the data located between (and may include) the start location and the stop location.

Additionally, in some embodiments, the genome analysis data server 120, or other computing device of the system 102, may determine one or more outlier metrics in block 216. The outlier metrics identify those data points falling outside a predetermined deviation of an average or median value. The outlier metrics may be identified by, for example, determining the average or median value of relevant data points and identifying those data points having values greater or lesser than a predetermined threshold value or deviation. In other embodiments, the outlier metrics may be determined by identifying the top and bottom three data points of the relevant data points. However, in other embodiments, other methods for determining outlier metrics may be used.

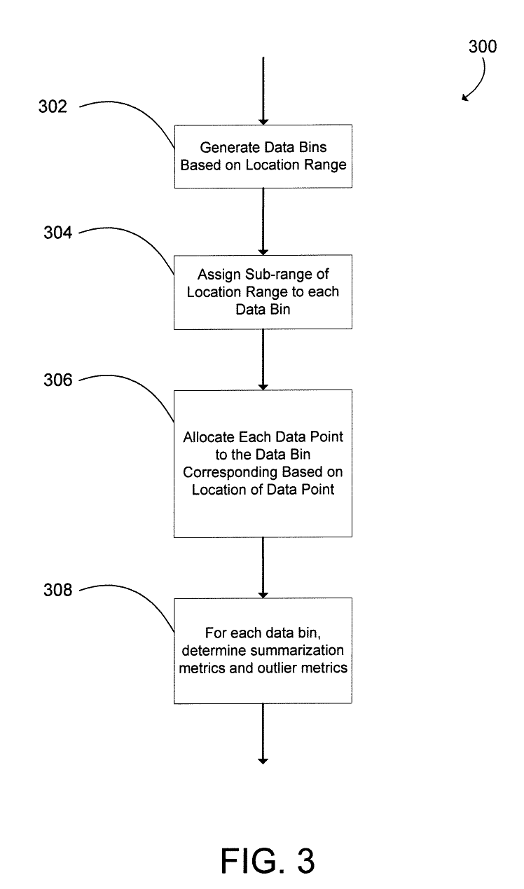

As discussed above, any one or more reduction methods may be used in block 214 to reduce the overall size of the genome analysis data such that the requested data may be transmitted to the client computer(s) 106 in a shorter period. One illustrative method 300 for reducing the genome analysis data is illustrated in FIG. 3 in which the genome analysis data is reduced by allocating each data point to a data bin and summarizing the contents of each data bin. The method 300 begins with block 302 in which data bins are generated for the location range identified by the request parameters supplied by the user of the client computer 106. As discussed above, the location range may be defined as the location between the start location and the stop location. The total number of data bins used may be determined based on hardware or software parameters. For example, in some embodiments, the total number of data bins is based on the size of the display 112 of the client computer 106 (e.g., larger displays can display more bins than smaller ones). It should be appreciated that the data bins may be embodied as memory or other storage locations.

In block 304, each data bin is assigned a sub-range of the location range. The particular sub-range represented by each data bin may be determined by dividing the total range of locations by the total number of bins. The sub-ranges may be of equal or different lengths. For example, the length of each sub-range may be determined based on the total number of data points located therein (i.e., sub-ranges of the location range having higher concentration of data points may be represented by a larger number of data bins in some embodiments). Subsequently, in block 306, each data point of the requested genome analysis data is allocated to one of the data bins. The data points are allocated based on the sub-range within which each data point is located. That is, the data point is allocated to the data bin associated with the sub-range in which the data point resides.

After the data points have been allocated to the data bins in block 306, each data bin is summarized in block 308. Additionally, in some embodiments, outlier metrics for the genome data as a whole or on bin-by-bin basis may be determined in block 308. For example, in one embodiment, the data allocated to each bin is summarized and reduced to a mean data value, a median data value, a minimum data value, and a maximum data value. Additionally, in some embodiments, any outlier metrics for that data bin may be determined. The outlier metrics may be determined using any suitable method such as those methods discussed above (e.g., the top and bottom three data points above/below the maximum and minimum values). In some embodiments, if a bin contains less than a predetermined minimum number of data points, the data points may not be summarized or reduced. For example, if a data bins includes six or less data points, the data bin may not be summarized or reduced further.

It should be appreciated that the reduction methods described above may result in small changes in the start location that could affect the data composition of each bin, thus altering the summary. As such, in some embodiments, the start location for data retrieval is rounded down to the closest number that is divisible by the range, wherein the range is the stop location minus the start location (stop location—start location), to ensure the bin compositions remain consistent.

Further, in other embodiments, other methods for reducing the genome analysis data may be used. For example, in some embodiments, box plotting may be used to reduce and summarize the genome analysis data (see, e.g., Massart et al., 2005, LC-GC 30 Europe 18:215-218). In such embodiments, data from each data bin are reduced to a mean, median, minimum, maximum and outlier metrics. If a data bin contains less than a predetermined number of data points, the data bin is not summarized. The descriptive statistics used to summarize the data are calculated using quartiles (Q) and the interquartile range (IQR). Quartiles are calculated by calculating the median (second quartile or Q2) of the values located in each data bin. The first quartile (Q1) is the median of all values below the second quartile. The third quartile (Q3) is the median of all values above the second quartile. The IQR is the difference between the third and first quartiles. Outliers are indicated by values that are less than 1.5×IQR lower than the first quartile or 1.5×IQR higher than the third quartile, where the value 1.5 is used to identify mild outliers. The minimum value is the smallest non-outlier value 10 and the maximum value is the largest non-outlier value.

Referring back to FIG. 2, once the genome analysis data has been reduced and summarized in block 214, the reduced genome dataset is transmitted to the client computer(s) 106 in block 218. It should be appreciated that, due to the relatively small size of the reduced genome dataset, the time required to transmit the reduced genome dataset is less than the time that would have been required to transmit the unreduced genome analysis data. For example, in some embodiments, the requested reduced microarray assay data may be transmitted to and visualized on the client computer 106 in less than 0.2 sec., less than 0.3 sec., less than 0.4 sec., less than 0.5 sec., less than 0.7 sec., less than 0.9 sec., less than 1 sec., less than 2 sec., less than 3 sec., less than 5 sec., less than 7 sec., and/or less than 10 seconds from transmitting the request for the genome data.

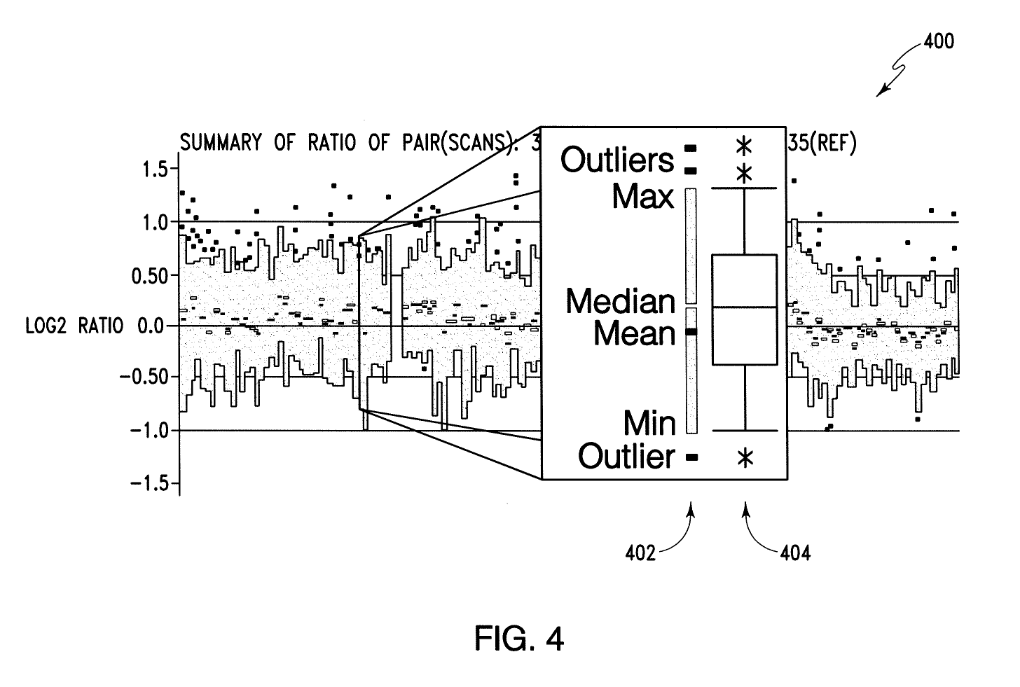

Once the reduced genome dataset is received by the client computer 106, the user may visualize the data on the associated display 112. The reduced genome dataset may be visualized using any suitable method and/or software. For example, one embodiment of an illustrative display screen 400 is illustrated in FIG. 4. In such embodiments, the genome data located at a particular location is summarized using a vertical bar graph 402 having indicia of a median value, a mean value, a maximum value, a minimum value and outlier values. Alternatively, a box graph 404 may be used to display the reduced genome data and illustrative includes indicia of a median value, a maximum value, a minimum value, and outlier values. Of course, other methods and visual constructs (e.g., histograms) may be used in other embodiments to visualize the reduced data. Additionally, the user may generate a hardcopy of the reduced data using an external printer or similar device and/or import the reduced data into other software applications for further analysis.

It should be appreciated that the system 100 described above is configured to determine, summarize, and reduce genome data generated from one or more genome assays. The type of genome data usable with the system 100 may embodied as any type of genome data including, but are not limited to, insertions, deletions, single nucleotide polymorphisms, when compared to reference data. The generated genome data is reduced to a smaller amount of information that summarizes the original genome data. Because the reduced genome data is smaller in size than the original genome data, the reduced genome data can be transferred to the client computer 106 in a short time period.

There is a plurality of advantages of the present disclosure arising from the various features of the apparatuses, circuits, and methods described herein. It will be noted that alternative embodiments of the apparatuses, circuits, and methods of the present disclosure may not include all of the features described yet still benefit from at least some of the advantages of such features. Those of ordinary skill in the art may readily devise their own implementations of the apparatuses, circuits, and methods that incorporate one or more of the features of the present disclosure and fall within the spirit and scope of the present invention as defined by the appended claims.

1. A system for analyzing genome data, the system comprising:
a processor; and
a memory device communicatively coupled to the processor, the memory device having stored therein a plurality of instructions, which when executed by the processor, cause the processor to:
receive genome analysis data generated by a genome analysis device, the genome analysis data comprising a plurality of data points;
receive a request for genome analysis data from a client computer over a wide area network, the request identifying a location range of interest of the genome analysis data;
reduce the genome analysis data located in the location range to generate a reduced genome dataset, wherein the reduced genome dataset comprises (i) a first number of data points that is less than a second number of data points of the genome analysis data located in the location range and (ii) outlier metrics; and
transmit the reduced genome dataset to the client computer over the wide area network in response to the request.

2. The system of claim 1, wherein to receive genome analysis data comprises to receive genome analysis data generated from a microarray assay performed using a microarray scanner.

3. The system of claim 2, wherein the microarray assay is one of a nucleic acid microarray assay and a peptide microarray assay.

4. The system of claim 2, wherein the microarray assay is a nucleic acid microarray assay comprising genomic deoxyribonucleic acid samples.

5. The system of claim 1, wherein the request identifies a start location and a stop location of the genome analysis data, the location range extending from the start location to the end location.

6. The system of claim 1, wherein the first number of data points is no greater than ten percent of the second number of data points.

7. The system of claim 6, wherein the first number of data points is no greater than one percent of the second number of data points.

8. The system of claim 1, wherein the size in bytes of the reduced genome dataset is less than about one percent of the size in bytes of the genome analysis data located in the location range.

9. The system of claim 1, wherein the outlier metrics comprises data points that represent at least one of (i) values above a determined maximum and (ii) values below a determined minimum.

10. The system of claim 1, wherein the outlier metrics comprises data points having numerical values falling outside a predetermined deviation range of a determined average value.

11. The system of claim 1, wherein the reduced genome dataset comprises a mean data point value, a median data point value, a minimum data point value, and a maximum data value.

12. The system of claim 1, wherein to reduce the genome analysis data comprises:
to define a plurality of data bins, each data bin being assigned an associated sub-range of the location range;
to allocate each data point of the genome analysis data located in a sub-range of the location range to the corresponding data bin; and
to summarize the plurality of data bins by defining at least a mean data point value, a median data point value, a minimum data point value, and a maximum data point value for each data bin.

13. The system of claim 1, wherein the wide area network comprises the Internet.

14. The system of claim 1, wherein the genome analysis data comprises first genome analysis data generated from an analysis of a test nucleic acid sample and second genome data analysis data generated from a reference nucleic acid sample, and the plurality of instructions further cause the processor to:
identify at least one data point of the first genome analysis data that is different in value from a corresponding data point of the second genome analysis data, wherein the reduced genome dataset comprises the at least one data point.

15. A method for analyzing genome data, the method comprising:
receiving, with a computer system, a request for gnome analysis data from a client computer over the Internet, the request identifying a location range of interest of the genome analysis data;
reducing, on the computer system, the genome analysis data located in the location range to generate a reduced genome dataset such that (i) the reduced genome dataset summarizes the genome analysis data located in the location range and (i) the size in bytes of the reduced genome dataset is no greater than one percent of the size in bytes of the genome analysis data located in the location range; and
transmitting the reduced genome dataset from the computer system to the client computer over a wide area network.

16. The method of claim 15, wherein reducing the genome analysis data comprises determining outlier metrics, the outlier metrics including data points having numerical values falling outside a predetermined deviation range of a determined average value.

17. The method of claim 15, wherein reducing the genome analysis data comprises determining a mean data point value, a median data point value, a minimum data point value, and a maximum data value based on the genome analysis data located in the location range.

18. The method of claim 15, wherein reducing the genome analysis data comprises:
defining a plurality of data bins, each data bin being assigned an associated sub-range of the location range;
allocating each data point of the genome analysis data located in a sub-range of the location range to the corresponding data bin; and
summarizing the plurality of data bins by defining at least a mean data point value, a median data point value, a minimum data point value, and a maximum data point value for each data bin.

19. The method of claim 15, wherein transmitting the reduced genome dataset comprises transmitting the reduced genome dataset from the computer system to the client computer over the Internet during a first time period that is less than a time period required to transmit the genome analysis data located in the location range to the client computer.

20. A tangible, machine readable medium comprising a plurality of instructions, that in response to being executed, result in a computing system:
receiving genome analysis data comprising first genome analysis data generated from a microarray analysis of a test nucleic acid sample and second genome data analysis data generated from a reference nucleic acid sample;
identifying at least one data point of the first genome analysis data that is different in value from a corresponding data point of the second genome analysis data;
reducing the genome analysis data located in the location range to generate a reduced genome dataset, wherein the reduced genome dataset comprises (i) a first number of data points that is less than a second number of data points of the genome analysis data and (ii) the at least one data point; and
transmitting the reduced genome dataset to a client computer over a wide area network in response to a request received from the client computer.
